(19) United States
(12) Patent Application Publication
(10) Pub. No.: US 2009/0229401 A1
(43) Pub. Date: Sep. 17, 2009

(54) Motion Transmitting Cable Liner and Assemblies Containing Same

(75) Inventors: Kim Reynolds, Berwyn, PA (US); Charles P. Marino, Philadelphia, PA (US); Kevin Kray, Phoenixville, PA (US)

Correspondence Address: FOX ROTHSCHILD LLP, 2000 MARKET STREET, 10th Floor, PHILADELPHIA, PA, 19103, US

(73) Assignee: Markel Corporation, Plymouth Meeting, PA (US)

(21) Appl. No.: 12/406,729

(22) Filed: Mar. 18, 2009

Related U.S. Application Data
(63) Continuation-in-part of application No. 11/922,870, filed on Mar. 27, 2009.
(60) Provisional application No. 61/037,660, filed on Mar. 18, 2008.
(60) Provisional application No. 60/694,356, filed on Jun. 25, 2005.

(51) Int. Cl. F16C 1/26; F16C 1/24

(52) U.S. Cl. 74/502.5

(57) ABSTRACT

Disclosed are cable assemblies, liners for cable assemblies and methods for making same. The liner in preferred embodiments comprises bearing surface with inwardly projecting surfaces, preferably at substantially regularly spaced intervals along the inner circumference of the bearing surface.

### RELATED APPLICATIONS

The present application is related to and claims the priority benefit of each of the following previously filed applications: U.S. provisional application 61/037,660 filed Mar. 18, 2008; International Application PCT/US06/24100, filed 21 Jun. 2006, which in turn claims priority to U.S. provisional application 60/694,356, filed 25 Jun. 2005; and U.S. application Ser. No. 11/922,870, filed 26 Dec. 2007, which is the national stage entry of the international application mentioned herein and which is currently pending. Each of the above identified applications is incorporated by reference herein as if fully set forth below.

### FIELD OF THE INVENTION

This invention relates generally to cable assemblies and liners for cable assemblies, and more particularly to cable assemblies of the type typically used (for example in automobiles) to transmit rotary or linear motion along a predetermined path. In a particular aspect, the present invention relates to liners having desirable frictional efficiency. The present invention relates also to motion transmitting cable assemblies having a liner in accordance with the present invention.

### BACKGROUND OF THE INVENTION

Motion and/or power transmitting cable assemblies are used in a large number of important commercial applications. One of the most common uses of such devices occurs in automotive, marine and aircraft installations. Although such cable assemblies are generally hidden from the view of the user, they nevertheless play an important role in many of these well-known modes of transportation. For example, many automobile accessories, such as heaters, air conditioners and side-view mirrors, are dependent upon such assemblies for convenient and reliable operation. Motion transmitting cable assemblies are also frequently indispensable components in the mechanisms used to control critical aspects of vehicle operation. For example, throttle and shift control cables are frequently used to control the speed and power of a vehicle, respectively. It will be appreciated, therefore, that reliable operation of such devices over long periods of use is critical to the safety of present day automobiles. It will also be appreciated that the ease, comfort and smoothness of use of such devices both initially and over long periods of use can play an important role in the commercial value of the product of which it is a part.

Generally, motion transmitting cable systems in common use today comprise a conduit and a motion transmitting core element movably disposed in the conduit. The conduit typically has fittings at each end thereof for attaching the cable assembly to a support structure. In one type of assembly, commonly referred to as a push-pull cable assembly, the cable core is both pushed and pulled to effect remote control of some servient mechanism, apparatus or device. When push-pull cable assemblies are operated in the push mode, the cable core is placed under a compressive load and a substantial lateral load is transmitted to the wall of the associated sheath or conduit. As a result, the side walls of the cable conduit or sheath are frequently subject to intermittent and potentially severe loading, depending upon the mode of operation. Another type of cable assembly is commonly referred to as a “pull-pull” cable assembly. In such assemblies, the core element is substantially always operated in tension, never in compression. While such assemblies do produce wear of the cable conduit and its liner, the wear is generally not as severe as with the push-pull type assemblies. In rotary type assemblies, the cable core is rotated in predetermined relation to an operating parameter, such as the speed of a motor vehicle. In such configurations, the conduit is also subject to abrasion as a result of contact with the rotating core.

Much effort has heretofore been directed to developing materials with properties advantageous for forming liners. For example, the assignee of the present invention has developed materials made from filled fluorocarbon polymers (see U.S. Pat. No. 6,040,384) and from cross linked polyethylene (see U.S. Pat. No. 4,898,046). While these developments have resulted in liners having advantages in many embodiments, applicants have discovered, as explained in more detail below, that certain liner geometries can be utilized to produce performance advantages without necessarily requiring a change in the materials from which the liner is made.

### SUMMARY OF THE INVENTION

Preferred aspects of the present invention are directed to cable assemblies, liners for cable assemblies and methods of making same.

One aspect of the present invention provides a liner comprising a guide means, preferably in the form of an enclosing structure having an inner bearing surface and also preferably in a generally tubular configuration. As used herein, the term “bearing surface” refers to a surface which in use is or will potentially be exposed to frictional contact with a moving member, that is, a member which in use is adapted to be in motion movement relative to the bearing surface, such as for example a motion transmitting cable. Applicants have discovered that performance advantages can be achieved by providing the bearing surface with inwardly projecting surfaces, preferably at substantially regularly spaced intervals along the inner circumference of the bearing surface. As used herein the term “inwardly projecting surface” refers to a surface of the enclosing structure which is closer to the center of the structure than one or more adjacent surfaces. For example, in the case of an enclosing structure which is a generally tubular structure, the inwardly projecting surface(s) preferably is closer to the longitudinal axis of the tubular structure than one or more circumferentially adjacent surfaces. It should be appreciated in addition that in the case of a generally tubular structure it may also be preferred in some embodiments that one or more of the longitudinally adjacent surfaces may also be further from the longitudinal axis than the inwardly projecting surface. In preferred embodiments, however, the surfaces longitudinally adjacent to the inwardly projecting surface are substantially the same distance from the longitudinal axis as the projecting surface. As used herein, the references to distances from the axis refer to the perpendicular distance from the axis.

While it is contemplated that the inwardly projecting surface may have any particular geometry or shape, it is generally preferred that the inwardly projecting surface is contoured or non-linear as measured along the inner circumference of the enclosing member. Furthermore, in preferred embodiments, the inwardly facing surface includes no substantial discontinuities in the circumferential direction. In other words, it is preferred in certain embodiments that no sharp corners or edges are included in the inwardly projecting surface or at the interface of the inwardly projecting surface and adjacent surfaces, particularly circumferentially adjacent surfaces.

In certain preferred aspects of the present invention, the inner bearing surface includes between adjacent inwardly projecting surfaces one or more containment regions, gaps, or troughs which normally provide for a relatively open region between the inner bearing surface and the outer surface of the motion transmitting member. While applicants do not wish to be necessarily bound by or to any particular theory of operation, it is believed that the existence of such containment regions or gaps provides the assemblies and liners of the present invention with substantial advantage in certain performance characteristics. By way of one example, applicants have found that the noise production characteristics of the assemblies, that is, the noise levels produced by operation of the assembly, are substantially reduced, and that such improvements are achieved in accordance with certain embodiments of the present invention, at least in part, as a result of the presence of such gaps or containment regions. In particular, in those common embodiments in which a lubricant is included in the assembly adjacent to the motion transmitting member, it is believed that the containment region or gap provides a location in which the lubricant will be exposed less to direct frictional interface between the liner and the cable. In such situations, the containment region, gap or trough provides an area in the nature of a reservoir for the lubricant. It is believed that the presence of such a structure improves the overall performance of the assembly, at least in part, by allowing for improved longevity and performance of the lubricant. It is also believed that the preferred trough or containment structure described herein may provide beneficial properties as a direct consequence of the structure independent of the lubricant performance. For example, it is believed that since the preferred structure of the present invention provides a reduction in contact area between the liner and the motion transmitting member at any given point in the time of operation, this arrangement in accordance with the present invention will produce not only extended life of the assembly but also a reduction in the noise producing characteristics of the assemblies.

It is contemplated that advantages can be achieved in accordance the present invention using a wide variety of materials of construction. It is generally preferred that the enclosing structure, such as the tubular conduit or liner, be formed from a polymeric material. In certain preferred embodiments the enclosing structure comprises, and even more preferably consists essentially of, one or more polymers formed from the melt state, such as by melt extrusion. In certain preferred embodiments, the enclosing member is formed of a low friction polymeric material such as thermoplastic fluoropolymer, including in preferred embodiments polymers which consist of or incorporate polytetrafluoroethylene (PTFE), melt fluoropolymers, thermoplastics, such as polyamide, such as the material sold by under the trade designation Nylon. The thermoplastic fluoropolymers in accordance with the present invention are preferred in many embodiments to be formed by processes which include ram extrusion of the polymer into the desired shape and configuration.

In certain embodiments it is desirable to use thermoplastic polymer and/or thermoplastic elastomer for the enclosing structure. Of course, the enclosing member may be multi-walled in certain embodiments, that is, the casing wall may be formed of multiple materials and/or in multiple layers. Furthermore, while the material from which the moving member is formed may also vary widely, in preferred embodiments the moving member is formed from steel, such as stainless steel wire or cable.

In general the inner surface of the enclosing member, and in particular the inwardly projecting surface portion(s) thereof, are adapted to be in operative relationship to a motion-transmitting member in the case of a motion transmitting assembly. Applicants have discovered that desirable characteristics can be produced by cable assemblies comprising an elongated core for transmitting force or torque along a predetermined path and guide means comprising a liner according to the present invention.

One aspect of the present invention provides cable assemblies, in particular motion transmitting cable assemblies, in which the liner portion of the assembly is in accordance with the enclosing member of the present invention. Applicants have found that the abrasion resistance and frictional efficiency of such assemblies, including over long cycle times, and potentially with high loads, can be improved relative to assemblies in which the liner is not in accordance with the present invention.

According to preferred embodiments of the apparatus aspects of the present invention, the guide means includes a bearing surface, preferably comprising polymeric material (including polymer composites), such that the present liner has an abrasion resistance of at least about 500,000 cycles of the ambient low load S-test, and even more preferably exhibit a frictional efficiency of at least about 88% over 500,000 cycles of the ambient low load S-test.

### BRIEF DESCRIPTION OF THE DRAWINGS

FIG. 1 is a perspective view of a liner in accordance with one embodiment of the present invention.

FIG. 2 is a cross section view of the cable liner illustrated in FIG. 1 taken along line 2-2.

FIG. 3 is a cross section view of the cable liner illustrated in FIG. 1 taken along line 3-3 in FIG. 2.

FIG. 4 is a semi-schematic representation of a cable assembly configuration according to one embodiment of the present invention.

FIG. 5 is a cross-sectional view taken along lines 2-2 of the cable assembly configuration as shown in FIG. 4 but using a liner in accordance with the prior art.

### DETAILED DESCRIPTION OF PREFERRED EMBODIMENTS

Cable assemblies are capable of utilizing numerous structural details, and it is contemplated that all such cable assemblies are adaptable for use in accordance with the present invention. One aspect of the present invention provides cable assemblies adapted to transmit motion along a predetermined path between two remotely located points. As mentioned above, the assemblies generally include a torque or force transmitting core member adapted to carry the torque or force along the predetermined path. The principal requirement of the core member is that it is of sufficient strength and durability to reliably withstand the various stresses and loads associated with the transmission of the force or torque. Many such motion-transmitting core members are well known in the art, and all are adaptable for use according to the present invention. According to certain preferred embodiments, the core is a stranded steel wire or rope having a generally circular cross-section and a diameter of from about 50 mils to about 150 mils.

According to an important and critical aspect of certain embodiments of the present apparatus, the guide means preferably includes a bearing member having at least one inwardly projecting surface of the present invention, preferably formed from a low friction material, and even more preferably in certain embodiments of a polymeric material formed into the desired shape from the melt state, for example, by melt extrusion or by ram extrusion. The inwardly projecting surfaces preferably at least contribute to the function of guiding the movement of the core member along the predetermined longitudinal path. Moreover, the inwardly projecting surface, in combination with the geometry and structure of the surfaces adjacent to the inwardly projecting surfaces, provide a gap, trough or containment region between at least two of the inwardly projection surfaces, and even more preferably between any two inwardly projecting surfaces.

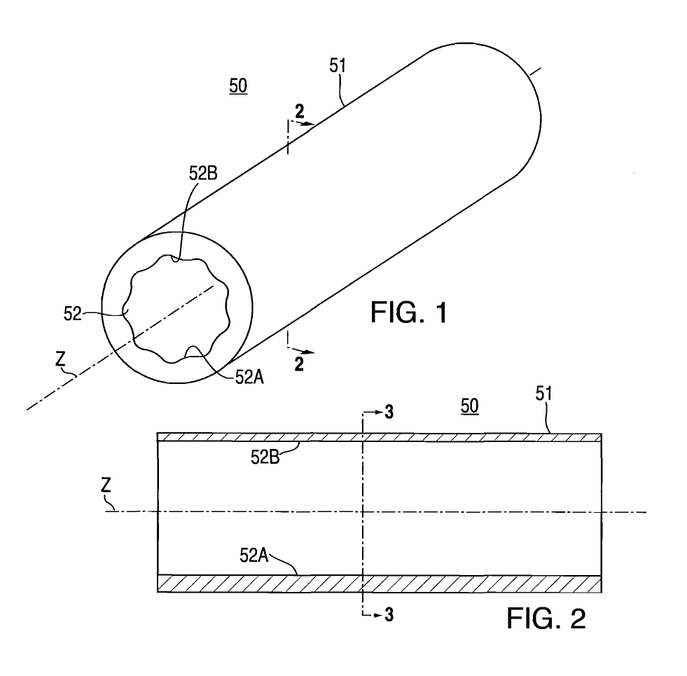

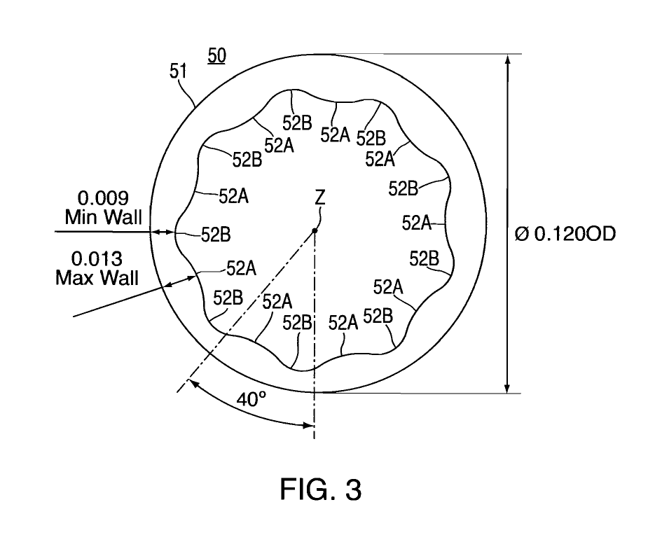

With particular reference now to FIG. 1, a perspective view of an enclosing member 50 in accordance with one embodiment of the present invention is illustrated. The enclosing member has a wall having an outer surface 51 and an inner surface 52. The configuration and geometry of the outer surface 51 is generally not important to the present invention, except that the wall should have sufficient thickness to provide the necessary strength and other required properties to the enclosing member. In the illustrated embodiment, referring now also to FIGS. 2 and 3, the outer surface 51 is generally circular in cross section. The inner surface 52 is comprised of a plurality of inwardly projecting surfaces 52A, and also preferably a plurality of valleys 52B. In preferred embodiments, the valleys 52B comprise the containment region, gap or trough mentioned above for preferably acting as a reservoir for the lubricant normally used in many such embodiments. In the illustrated embodiment, each surface 52A has an apex or peak which is closest to the longitudinal axis Z of the tubular member. In accordance with the preferred embodiments, the surfaces circumferentially adjacent to each peak or apex is further from the axis Z than the peak to which it is adjacent, as best illustrated in FIG. 3. In preferred embodiments, the surface(s) longitudinally adjacent to the peak or apex is substantially the same distance from the Z axis; that is, certain preferred liners of the present invention do not have any substantial peaks or valleys for a substantial distance along the longitudinal direction, and preferably along the entire length of the liner. This is best illustrated in FIG. 2 wherein it is seen that the circumferential peak 52A, represented by the greater wall thickness in the illustrated embodiment, is at all points along its longitudinal length substantially the same distance from the Z axis, and likewise for the circumferential valley 52B, represented by the lesser wall thickness in the illustrated embodiment.

Also, as is consistent with the preferred embodiments, the inner surface of the preferred guiding means falls circumferentially away from the apex in a substantially continuous, curvilinear manner until a valley or trough 52B is reached. Likewise, it is generally preferred that the inner surface of the preferred guiding means rises circumferentially towards the apex in a substantially continuous, curvilinear manner until the peak is reached, and this pattern is preferably repeated along the entire circumferential inner surface of the liner or other enclosing member.

Although it is contemplated that the number of inwardly facing projections used in accordance with the present invention may vary widely, in general it is preferred, especially for certain motion transmitting cable assembly embodiments, for the guide means to include at least three, and more preferably up to about 20 inwardly facing projections, with from about 8 to about 10 projections being preferred in certain embodiments. In preferred embodiments, the projections are substantially equally spaced along the inner circumference of the liner, preferably in certain embodiments having a pitch of from about 20° to about 60°. Although applicants do not intend to be necessarily bound by or to any particular theory of operation, it is believed that advantage is achieved according to the present invention by providing a finite number of leading support regions for the motion transmitting member. In operation, the cable liner is preferably configured such that each inwardly facing projection is substantially the same as each other projection, thereby reducing the area of contact between the cable and the liner, which in turn tends to reduce the frictional contact points. As a result, it is believed that the frictional efficiency and/or the longevity of the liner are enhanced, and in certain embodiments so is the performance and longevity of the lubricant used therewith. Furthermore, by forming the inward projections so as to be part of a substantially curvilinear surface, and preferably a curvilinear surface having the degree of curvature described below, the motion transmitting cable has a low friction path to contact other, non-apex inner surfaces areas of the liner as may frequently occur. For example, in use the liner will frequently follow a path with many turns and twists in the longitudinal direction, and this path may also sometimes be somewhat dynamic, that is, subject to change, depending on the particular force being transmitted and/or other factors. Thus, the use of substantially continuous curvilinear surfaces in the transition from apex to apex is believed to result in substantial advantage since the core may more readily move off and onto one or more of the apex surfaces in such a dynamic situation.

In order to obtain operative movement between the core and guide means of the present invention, the cable assemblies of the present invention commonly require that a gap or clearance exist between the outer surface of the core and the guide means in general and the inward projections in particular. It will be understood by those skilled in the art that the amount of gap or clearance which is provided by any particular cable assembly configuration is a function of numerous variables, including the contemplated routing for the assembly, the type of motion the assembly will be used to transmit and the extent of the load to be transmitted. Accordingly, all such gaps and clearances which permit the repetitive relative movement between the core and the guide means under the conditions of expected use are within the scope of the present invention. In certain preferred embodiments, however, the gap between the outer diameter of the core and the diameter defined by the series of apexes in the inwardly projecting surfaces is 0.015 inches. Furthermore, the dimensions which are used for the cable liner may also vary widely. In preferred embodiments, the cable liner has an outer diameter of from about 0.05 inches to about 0.2 (more preferably about 0.08 to about 0.15 inches), a minimum wall thickness of from about 0.008 to about 0.012 (more preferably from about 0.009 inch to about 0.011 inch) and a maximum wall thickness of from about 0.012 to about 0.018 (more preferably from about 0.012 inch to about 0.015 inch). Thus, in the case of the particular dimensions illustrated in FIG. 1, minimum wall thickness is about 0.009 inches and the maximum wall thickness is about 0.013 inches, thus producing a diameter as defined by the series of apexes in the inwardly projecting surfaces of about 0.094 inch. In such preferred embodiments having a desired gap between the outer diameter of the core and the diameter defined by the series of apexes in the inwardly projecting surfaces of about is 16 mils (0.016 inches), the preferred core diameter will be about 0.062 inches. For cable assemblies of the general type illustrated in FIG. 1, it is generally preferred that the gap or clearance is from about 0.5 mil to about 20 mil, with a gap from about 10 mil to about 18 mil being even more preferred. It will be appreciated by those skilled in the art that the gap will not necessarily be a constant and uniform spacing along the entire length of the cable assembly, especially cable assemblies used in serpentine routings. Accordingly, the term “gap” is generally used herein to define the distance between the outer surface of the core and the inner surface of the guide means (as defined by the apex of the inwardly projecting surface) based upon the relative dimensions of those elements.

In preferred embodiments, the inwardly projecting surface has a radius of curvature that is relatively large, that is, it tends not to form relatively sharp points or steep areas relative to the curvature of the core which it will be supporting. Thus, in certain embodiments, particularly those in which the cable radius as measured at the outer surface (CR) is from about 0.025 inch to about 0.1 inch, the inwardly projecting surface has a radius of curvature of from about 0.015 inches to about 0.45 inches. It is generally preferred that the ratio of the radius of curvature of the projection (PR) to the cable radius (CR), that is PR:CR, is at least about 0.5, more preferably at least about 2, more preferably at least about 10 and in certain embodiments even more preferably at least about 15. In certain embodiments, the radius of curvature of the inwardly projecting portion is about 0.30 inch.

The abrasion resistant, high efficiency compositions which form the liner in certain aspects of the present invention preferably comprise a major proportion by weight of a polymeric material. The polymeric material used in accordance with the present invention may be any one or more of many know materials, including thermoplastic polymers, thermosetting polymers, thermoplastic elastomers and combinations of two or more of these. In certain preferred embodiments, the polymeric material comprises a polyamide resin, such as Nylon resins, particularly Nylon 6. In other preferred embodiments, the liner material comprises at least one fluorocarbon polymer. In many preferred embodiments the polymeric material is present in the liner material in an amount that is at least about 50% by weight, and the liner material in certain embodiments further comprises less than about 40% by weight of filler, preferably comprising one or more organic fillers such as polyimide resin filler, polyphenylene sulfide resin filler and the like. The compositions may optionally include inorganic fillers, lubricants, pigments and other modificants as will be appreciated by those skilled in the art. According to certain preferred embodiments, the composites of the present invention consist essentially of from about 75% to about 98% by weight of fluorocarbon polymer and from about 2% to less than about 25% by weight of organic resin. As the term is used herein, fluorocarbon polymer refers to and is intended to include not only a single fluorocarbon polymer entity but also a mixture of any two or more fluorocarbon polymer entities. Fluorocarbon polymer suitable for use according to the present invention include a wide variety of fluorocarbon polymers but preferably comprise polytetrafluoroethylene (“PTFE”). PTFE polymers useful in the practice of the present invention preferably comprise a major proportion of PTFE homopolymer, although it is contemplated that copolymers of tetrafluoroethylene with other fluorocarbon monomers may also be used according to some embodiments. According to preferred embodiments, the fluorocarbon polymer of the present invention comprises a PTFE polymer formed by the copolymerization of PTFE monomer and from about 0% to about 2% by weight of chlorotrifluoroethylene monomer. Such a preferred fluoropolymer is available from Daikin Corporation under the trade designation F201. It will be appreciated by those skilled in the art that minor amounts of other comonomers, such as hexafluoropropylene or perfluoropropylvinylether may be used in place of or in addition to the chlorotrifluoroethylene comonomer in the preferred fluorocarbon polymer. The PTFE polymer suitable for use in the composites of the present invention include conventional PTFE polymers obtained by conventional means, for example, by the polymerization of tetrafluoroethylene under pressure using free radical catalysts such as peroxides or persulfates.

According to especially preferred aspects of the present invention, the PTFE polymer resins are paste extrudable polymer resins. Such resins are generally in the form of extrusion grade powders, fine powders, and the like. The preferable PTFE powders are dispersion grade and not granular. Techniques for the production of fine PTFE powders are well known, and the use of polymers produced by any of these techniques is well within the scope of this invention. For example, fine PTFE powder may be produced by coagulating colloidal PTFE particles as disclosed in U.S. Pat. No. 4,451,616, which is incorporated herein by reference.

The liner material may optionally include further additives such as lubricating fluids, inorganic fillers, pigments and other modificants generally known to those skilled in the art. Useful inorganic fillers include glass, metal and metal oxide components. These and other inorganic fillers can generally be employed in the form of beads, fibers, powders, liquids and the like as is well understood by those skilled in the art. Inorganic fillers may be incorporated in amounts sufficient to impart the desired in tensile strength as is well understood by those skilled in art.

Methods for formulating polymer composites are well known to those skilled in the art and may be used in formulation of the composites of the present invention. One preferred method for formulating such composites comprises mixing PTFE powder resin, and preferably fine PTFE powder resin, with organic powder resin. Any well known mixing process that achieves homogeneous and uniform mixing may be employed, although mixing by tumbling in a suitable commercial blender such as a Patterson Kelly Twin Shell at temperatures up to about 65° F. for a period of about 3 minutes is generally preferred. In formulating, it has been found that the PTFE and the organic resins are preferably in powder form, with the PTFE resin having in preferred embodiments a particle size of from about 450 microns to about 550 microns, and the organic filler generally have an average particle size estimated to be from about 2 to about 50 microns.

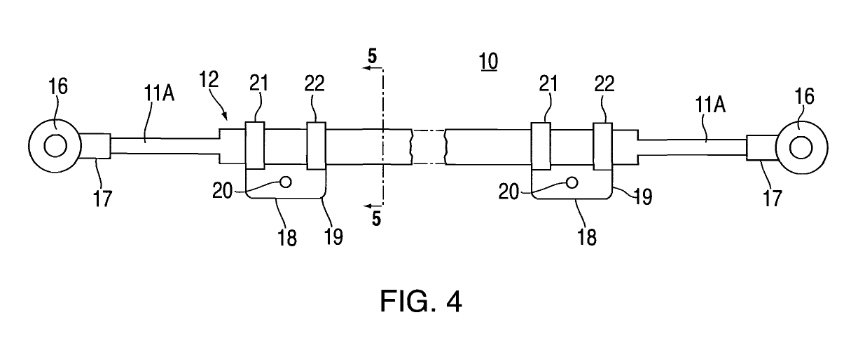

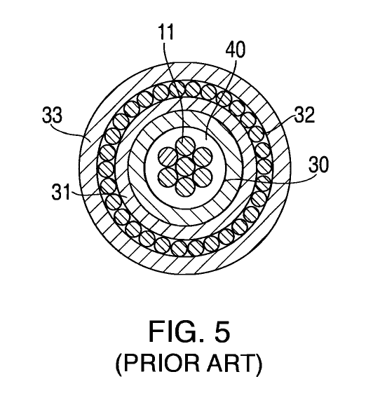

The present invention will now be described below in connection with a cable assembly adapted for transmitting motion in a longitudinal direction. It will be appreciated by those skilled in the art, of course, that such embodiments are illustrative only and are not limiting of the present invention. For example, cable assemblies according to the present invention are readily adaptable for transmitting rotary motion along a predetermined path. Referring now to FIGS. 4 and 5, a typical push-pull or pull-pull cable assembly configuration is illustrated. The cable assembly, indicated generally at 10, comprises a motion transmitting core 11 surrounded by guide means in the form of a casing or conduit, indicated generally at 12, for guiding the motion of core 11 along its predetermined path. According to the embodiment shown in FIG. 5, core 11 may consist of a stranded wire cable of the type shown in U.S. Pat. No. 4,362,069. Other configurations of core 11 are possible and within the scope of the present invention. It should be noted, however, that the inner surface configuration of the liner 30 as illustrated in FIG. 5 is in accordance with typical prior art construction since it does not include any inwardly facing projections. In accordance with the present invention, an enclosing structure as described herein is substituted for the liner 30.

With particular reference now to FIG. 4, the core 11 is seen as including an end portion 11A which projects lengthwise beyond the end of the casing 12. The length of the projecting end portion 11A of core 11 depends upon the lengthwise sliding movement of the core with respect to casing 12. In typical configurations, the cable assembly 10 is adapted to operatively connect an actuating device, such as an accelerator pedal (not shown), and an operable mechanism, such as an automobile carburetor control mechanism (also not shown). Means in the form of a pair of eyelet members, designated generally as 16, are provided on the ends 11A of the core 11 for operatively connecting the cable assembly 10 between the actuator and its associated device. Each of the eyelets 16 comprises a generally ring-shaped connecting section and a hollow, sleeve-like mounting section 17 adapted to receive the ends of the core 11A and be secured thereto by crimping or the like. The casing 12 is provided with means for fixedly securing the cable assembly 10 in a predetermined operative position. According to the embodiment shown in FIG. 4, such means is provided by a suitable support bracket 18 comprising a generally flat mounting section 19 having an opening 20 adapted to receive a suitable mounting bolt or the like (not shown). Integrally connected to one edge of the bracket 19 is a pair of tab-like elements 21 and 22 secured to outer casing 12.

The configuration of conduit 12 will now be described in more detail in connection with FIG. 5, which is in accordance with another invention of the assignee of the present invention, as described in U.S. application Ser. No. 10/889,812, which is incorporated herein by reference. Although the following description relates to the special case of a multi-layer conduit, it will be appreciated that the present invention is not so limited and that single or other types of conduits and liners may be used. The conduit 12 in the illustration of FIG. 5 is a multi-layered tubular conduit comprising a polymer composite liner 30 immediately surrounding core 11. As illustrated in FIG. 3, a gap or clearance 40 exists between liner 30 and the enclosed core 11. As mentioned hereinbefore, the particular gap employed in any cable assembly configuration will vary widely, depending upon numerous factors and constraints not related to the present invention. An inner wrap 31 surrounds the liner 30. Inner wrap 31 may comprise a closed wrapping of flat wire or a plastic tubular sheath surrounding liner 30. As is known to those skilled in the art, a primary purpose of the inner wrap 31 is to aid in maintenance and control of the shape and dimension of liner 30. According to the embodiment shown in FIG. 5, a full compliment of lay wire 32 surrounds inner wrap 31. As will be appreciated by those skilled in the art, the use of a full compliment of lay wire provides added resistance to axial compressive load deflection. Of course, the lay wire may be spaced or even omitted when such axial load deflection resistance is not an important requirement, such as may be the case in certain pull-pull type cable assemblies. In certain other embodiments, an outer wrap of flat wire or other material (not shown) may encircle the lay wire, as is understood by those skilled in the art. An outer jacket 33 encases the lay wire 32. The outer jacket 33 preferably comprises a material which provides physical integrity to the cable conduit, such as polypropylene or polyamide resins.

### EXAMPLES

The following examples, set forth by way of illustration but not limitation, depict the improved results achievable by the present cable assemblies which utilize the present guide means. In certain of the examples which follow, the performance of a liner for a pull-pull type cable assembly was evaluated using what is referred to herein as a “S-test.” This test is conducted using an “S” shaped fixture wherein the curvilinear portions of the inner radii of the “S” fixture extend about 120°. A 7×7 stranded and swagged stainless steel core member having a diameter of about 62 mils is drawn through the tubular liner in a reciprocating manner at a rate of about 60 cycles per minute. The liner has an inner diameter (as defined hereinbefore) of about 98 mils and an outer diameter of about 120 mils. Thus, a gap of about 18 mils exists between the core and the liner. A silicone-based oil is provided as a lubricant in the core in certain of the examples, as is common. Each S-test cycle consists of a forward travel of about one and one-half inches and a like return. Frictional efficiency and abrasion resistance are determined by applying an operating load to one end of the core member of the cable assembly as it travels along the S-shaped path. The operating load is applied by either a spring or a weight. Frictional efficiency measurements are taken at various intervals of cycles by employing a load cell (transducer) and recording the actual load necessary to move the cable over the surface of the liner at four cycles per minute. For the actual measurement, the operating load is replaced by a five pound dead weight. The frictional efficiency is calculated as a percentage by dividing the measured force into the five pound dead weight. When the spring is the operating load, it exerts about 6 pounds of force in the fully retracted position of the S-test cycle and about 18 pounds of force in the fully expanded position of the S-test cycle. For the purposes of convenience, the term “low load frictional efficiency” refers to a frictional efficiency determined using a spring of the type described above. The S-test apparatus is adapted to be operated under both ambient conditions and at conditions of elevated temperature. For the purposes of convenience, an S-test according to the procedures described above which is conducted under ambient conditions is referred to herein as an “standard ambient S-test.” According to preferred embodiments, the present liners exhibit exceptional abrasion resistance and frictional efficiency, and preferably also reduced noise production characteristics.

### Comparative Example 1

A low load ambient S-test was conducted to establish the frictional efficiency, under low loads and at room temperature, of a cable assembly having a PTFE conduit filled with about 10% by weight of polyarylene sulfide as disclosed in U.S. Pat. No. 4,362,069. The polymer composite was extruded into a tubular product having an inside diameter of 0.098 inches and an outside diameter of about 0.120 inches. The tubular product thus formed had a wall thickness of about 0.01 inches and was subjected to the low load, ambient S-test, as described above.

The initial frictional efficiency of the assembly using the PPS filled liner (liner A in Table I) was found to be 86.2%. The frictional efficiency was found to decline, as indicated in Table I, until the frictional efficiency at about 500,000 cycles of the low load ambient S-test was found to be 84.75%.

### Comparative Example 2

A low load ambient S-test is conducted to establish noise production under low loads and at room temperature of a cable assembly having a PTFE conduit filled with about 10% by weight of polyarylene sulfide as disclosed in U.S. Pat. No. 4,362,069. The polymer composite is extruded into a tubular product having a substantially circular inside diameter of 0.098 inches and an outside diameter of about 0.120 inches. The tubular product thus formed had a wall thickness of about 0.01 inches and was subjected to the low load, ambient S-test, as described above.

The initial noise production of the assembly is measured according accepted techniques. The noise production of the assembly is again measured according accepted techniques after 250,000 cycles and again after 500,000 cycles of the low load ambient S-test.

### Example 1

A low load ambient S-test was performed to show the improved frictional efficiency of cable assemblies having liners according to the present invention. A liner was formed as in Comparative Example 1, except the inner surface was as indicted in FIGS. 2 and 3. The tubular product was subject to the low load, ambient S-test, as described in Comparative Example 1A. The initial frictional efficiency was found to be 88.5%, an increase over the initial frictional efficiency of the liner tested in Comparative Example. Also the frictional efficiency after 400,000 cycles was substantially undiminished, and ended with a value of 86.2% after 500,000 cycles of operation.

TABLE I

| | Initial | After | | | | | |
|---|---|---|---|---|---|---|---|
| | Frictional | 50K | | | | | |
| | Efficiency | cycles | 100K | 200K | 300K | 400K | 500K |
| Comparative | 88.5 | 88.9 | 89.2 | 89.2 | 88.9 | 88.6 | 86.2 |
| Example 1 | | | | | | | |
| Example 1 | 86.2 | 86.2 | 86.0 | 86.0 | 86.5 | 86.2 | 84.7 |

### Example 2

A low load ambient S-test is performed to show the improved noise production characteristics of cable assemblies having liners according to the present invention. A liner was formed as in Comparative Example 2, except the inner surface was as indicted in FIGS. 2 and 3. The tubular product was subject to the low load, ambient S-test, as described in Comparative Example 2. The noise production is found to be less than the initial noise production of the assembly in Comparative Example 2. The preferred extent of noise production is reported in Table 2 below:

TABLE 2

| | | Reduction % | Reduction % |
|---|---|---|---|
| | Initial Noise | After 250K | After 500K |
| | Reduction % | cycles | cycles |
| Preferred | >10% | >10% | >10% |
| Noise Reduction | | | |
| More Preferred | >15% | >15% | >15% |
| Noise Reduction | | | |
| Even More Preferred | >25% | >25% | >25% |
| Noise Reduction | | | |

It will be appreciated by those skilled in the art that the preferred embodiments disclosed herein are illustrative of the present invention but not limiting thereof. Accordingly, modifications of the disclosed embodiments are possible without departing from the proper scope of the present invention, which is defined by the claims which follow.

What is claimed is:

1. A motion transmitting cable assembly comprising:
an elongated core for transmitting a force along a predetermined path; and
an abrasion resistant enclosing structure against which said core bears as it transmits the force along said predetermined path, said enclosing structure having a low friction inner surface, said inner surface including at least two inwardly projecting bearing surface and at least one trough between said inwardly projecting bearing surfaces.

2. The motion transmitting cable assembly of claim 1 further comprising lubricant between said abrasion resistant enclosing structure and said core.

3. The motion transmitting cable assembly of claim 2 wherein at least a portion of said lubricant is located in said trough.

4. The motion transmitting cable assembly of claim 1 having an initial noise production in a low-load ambient S-test operation that is less than the noise production of the same assembly in the absence of said trough.

5. The motion transmitting cable assembly of claim 4 having an initial noise production in a low-load ambient S-test operation that is at least about 10% less than the initially noise production in substantially the same assembly in the absence of said at least one trough.

6. The motion transmitting cable assembly of claim 4 having an initial noise production in a low-load ambient S-test operation that is at least about 20% less than the initial noise production in substantially the same assembly in the absence of said at least one trough.

7. The motion transmitting cable assembly of claim 4 having an initial noise production in a low-load ambient S-test operation that is at least about 30% less than the initial noise production in substantially the same assembly in the absence of said at least one trough.

8. The motion transmitting cable assembly of claim 4 having an initial noise production in a low-load ambient S-test operation that is at least about 50% less than the initial noise production in substantially the same assembly in the absence of said at least one trough.

9. The motion transmitting cable assembly of claim 1 having a noise production in a low-load ambient S-test after 250,000 cycles of operation that is lower than the noise production after 250,000 cycles of operation of the same assembly in the absence of said trough.

10. The motion transmitting cable assembly of claim 9 having a reduced noise production in a low-load ambient S-test operation after 250,000 cycles of operation that is at least about 10% less than the noise production after 250,000 cycles of operation in substantially the same assembly in the absence of said at least one trough.

11. The motion transmitting cable assembly of claim 9 having noise production in a low-load ambient S-test operation after 250,000 cycles of operation that is at least about 20% less than the noise production after 250,000 cycles of operation in substantially the same assembly in the absence of said at least one trough.

12. The motion transmitting cable assembly of claim 9 having noise production in a low-load ambient S-test operation after 250,000 cycles of operation that is at least about 30% less than the noise production after 250,000 cycles of operation in substantially the same assembly in the absence of said at least one trough.

13. The motion transmitting cable assembly of claim 9 having noise production in a low-load ambient S-test after 250,000 cycles of operation that is at least about 50% less than the noise production after 250,000 cycles of operation in substantially the same assembly in the absence of said at least one trough.

14. The motion transmitting cable assembly of claim 1 having a noise production in a low-load ambient S-test after 500,000 cycles of operation that is lower than the noise production after 500,000 cycles of operation of the same assembly in the absence of said trough.

15. The motion transmitting cable assembly of claim 14 having a reduced noise production in a low-load ambient S-test operation after 500,000 cycles of operation that is at least about 10% less than the noise production after 500,000 cycles of operation in substantially the same assembly in the absence of said at least one trough.

16. The motion transmitting cable assembly of claim 14 having noise production in a low-load ambient S-test operation after 500,000 cycles of operation that is at least about 20% less than the noise production after 500,000 cycles of operation in substantially the same assembly in the absence of said at least one trough.

17. The motion transmitting cable assembly of claim 14 having noise production in a low-load ambient S-test operation after 500,000 cycles of operation that is at least about 30% less than the noise production after 500,000 cycles of operation in substantially the same assembly in the absence of said at least one trough.

18. The motion transmitting cable assembly of claim 14 having noise production in a low-load ambient S-test after 500,000 cycles of operation that is at least about 50% less than the noise production after 500,000 cycles of operation in substantially the same assembly in the absence of said at least one trough.

19. The motion transmitting cable assembly of claim 1 wherein said load bearing frictional surface comprises at least one thermoplastic polymer.

20. The motion transmitting cable assembly of claim 1 wherein said load bearing frictional surface comprises at least one polyamide resin.

21. The motion transmitting cable assembly of claim 1 wherein said load bearing frictional surface is formed at least in part by melt extrusion.

22. The cable assembly of claim 1 said at least one inwardly projecting bearing surface comprises plural inwardly projecting bearing surfaces.

23. The cable assembly of claim 1 wherein said inwardly projecting bearing surface comprises PTFE.

24. The cable assembly of claim 1 wherein said at least one inwardly projecting bearing surface comprises a plurality of inwardly projecting bearing surfaces said surfaces being located at substantially regularly spaced intervals.

25. The cable assembly of claim 1 wherein said enclosing structure is a generally tubular structure.

26. The cable assembly of claim 25 wherein said inner surface includes no substantial discontinuities in the circumferential direction.

27. The motion transmitting cable assembly of claim 1 wherein said load bearing frictional surface comprises at least one thermoplastic fluoropolymer.

28. The motion transmitting cable assembly of claim 1 wherein said load bearing frictional surface comprises at least PTFE.

29. The motion transmitting cable assembly of claim 27 wherein said load bearing frictional surface comprises at least one additional polymeric material other than said thermoplastic fluoropolymer.

30. The motion transmitting cable assembly of claim 1 wherein said load bearing frictional surface is formed at least in part by ram extrusion.
